(19) United States
(12) Patent Application Publication
(10) Pub. No.: US 2026/0160971 A1
(43) Pub. Date: Jun. 11, 2026

(54) ADJUSTABLE MOBILE PHONE LENS CLAMP

(71) Applicant: SHENZHEN NEEWER TECHNOLOGY CO. LTD, Shenzhen (CN)

(72) Inventors: Jiawei HE, Shenzhen (CN); Yan KE, Shenzhen (CN); Jun WANG, Shenzhen (CN)

(73) Assignee: SHENZHEN NEEWER TECHNOLOGY CO. LTD, Shenzhen (CN)

(21) Appl. No.: 19/026,227

(22) Filed: Jan. 16, 2025

(30) Foreign Application Priority Data
Dec. 6, 2024 (CN) 202423021346.8

(51) Int. Cl. G02B 7/02; G03B 17/56; G03B 30/00

(52) U.S. Cl. CPC G02B 7/023; G03B 17/565; G03B 30/00

(57) ABSTRACT

Disclosed is an adjustable mobile phone lens clamp, including a mobile phone clamping apparatus and a lens connection arm. The mobile phone clamping apparatus is provided with a mobile phone clamping slot, and the lens connection arm is provided with a lens mounting portion. The lens connection arm is slidably provided at the mobile phone clamping apparatus and is rotatably connected to the mobile phone clamping apparatus, and one end of the lens connection arm provided with the lens mounting portion is configured to rotate around a joint intersection between the lens connection arm and the mobile phone clamping apparatus.

### CROSS-REFERENCE TO RELATED APPLICATIONS

The present application claims priority to Chinese Patent Application No. 202423021346.8, filed on Dec. 6, 2024, the content of which is incorporated herein by reference in its entirety.

### TECHNICAL FIELD

The present application relates to the technical field of mobile phone lens clamp, and in particular to an adjustable mobile phone lens clamp.

### BACKGROUND

As the most common photography tool at present, the built-in lens of the mobile phone often cannot meet the special shooting requirements such as long-distance, microscopic, and fisheye. In order to broaden the shooting effect of the mobile phone camera, the mobile phone lens clamp came into being, which can be conveniently attached to mobile phone to install various extension cameras, lenses or filters, which greatly improves the diversity of the mobile phone photography.

The mobile phone lens clamp on the market is mainly divided into two types: clip type and bracket type. Although the clip type lens clamp is easy to carry, the application scope of which is limited and it is not compatible with heavier large lenses. In contrast, although the bracket type lens clamp has a wider range of applicability, it usually has a larger frame structure, which requires the extension lens to be translated and slid within the frame to match the position of the mobile phone camera. However, this extension lens is very inflexible when adjusting its position by translation and sliding within the frame.

### SUMMARY

The main purpose of the present application is to provide an adjustable mobile phone lens clamp, aiming to improve the flexibility of the mobile phone lens clamp when adjusting.

To achieve the above purpose, the present application provides an adjustable mobile phone lens clamp, including a mobile phone clamping apparatus provided with a mobile phone clamping slot, and a lens connection arm provided with a lens mounting portion. The lens connection arm is slidably provided at the mobile phone clamping apparatus and is rotatably connected to the mobile phone clamping apparatus, and one end of the lens connection arm provided with the lens mounting portion is configured to rotate around a joint intersection between the lens connection arm and the mobile phone clamping apparatus.

In an embodiment, the adjustable mobile phone lens clamp further includes a first fastening apparatus, the first fastening apparatus includes a first fastener and a first knob, and the mobile phone clamping apparatus is provided with a first mounting hole; the lens connection arm is provided with a first through hole, and the first fastener is configured to pass through the first through hole and extend into the first mounting hole to be connected to an inner wall of the first mounting hole; and the first knob is provided at one side of the lens connection arm facing away from the mobile phone clamping apparatus and is connected to the first fastener, and the first knob is abutted against a periphery of the first through hole.

In an embodiment, the first through hole is a strip-shaped hole, and the first fastener is through the first through hole and is configured to move along the first through hole.

In an embodiment, the first fastening apparatus further includes a sliding block sleeved at the first fastener and slidably connected to an inner wall of the first through hole.

In an embodiment, the lens connection arm includes a first connection arm and a second connection arm, the first connection arm is slidably provided at the mobile phone clamping apparatus and is rotatably connected to the mobile phone clamping apparatus, and the second connection arm is provided with the lens mounting portion; and the second connection arm is slidably connected to the first connection arm and is fixed in response to sliding to any position relative to the first connection arm, so as to adjust a distance between the lens mounting portion and the mobile phone clamping apparatus.

In an embodiment, the second connection arm is provided with a sliding rail extending in a direction from the first connection arm to the mobile phone clamping apparatus, the first connection arm is provided with a sliding groove extending in the direction from the first connection arm to the mobile phone clamping apparatus, and the sliding rail is slidably connected to an inner wall of the sliding groove.

In an embodiment, a sidewall of the sliding rail is provided with a convex rib extending in the direction from the first connection arm to the mobile phone clamping apparatus, a sidewall of the sliding groove is provided with a limiting groove extending in the direction from the first connection arm to the mobile phone clamping apparatus, and the convex rib is slidably connected to an inner wall of the limiting groove.

In an embodiment, the adjustable mobile phone lens clamp further includes a second fastening apparatus, the second fastening apparatus includes a second fastener and a second knob; bottom wall of the sliding groove is provided with a second through hole, the second through hole is a strip-shaped hole, and a second mounting hole is provided on one side of the sliding rail towards the bottom wall of the sliding groove; and the second fastener is configured to pass through the second through hole and is connected to an inner wall of the second mounting hole, and the second knob is provided on one side of the second through hole facing away from the sliding groove and is connected to the second fastener.

In an embodiment, the mobile phone clamping apparatus includes a first clamping claw, a connection block rotatably connected to the lens connection arm, a sliding rod, a spring and a second clamping claw; the first clamping claw is fixedly connected to the connection block, a blind hole is provided on one side of the first clamping claw facing away from the connection block, the blind hole is configured to extend along a direction from the first clamping claw to the connection block and extend into the connection block, and a third through hole is provided on a bottom wall of the blind hole; the sliding rod is slidably through the third through hole and is configured to extend outside the connection block, a boss is provided on a sidewall of the sliding rod, and the boss is limited in the blind hole; the second clamping claw is provided on one side of the connection block facing away from the first clamping claw and connected to the sliding rod, and the clamping slot is formed between the first clamping claw and the second clamping claw; and the spring is sleeved at the sliding rod and is connected to the boss and the bottom wall of the blind hole, and the spring is in a compressed state.

In an embodiment, the lens mounting portion is any one of a threaded mounting hole, a magnetic seat, a buckle and a clip.

In an embodiment, the adjustable mobile phone lens clamp further includes a lens adapter ring detachably connected to an inner wall of the lens mounting portion, and the lens adapter ring is provided with at least two lens adapter grooves.

The adjustable mobile phone lens clamp provided in the present application includes a mobile phone clamping apparatus and a lens connection arm. The mobile phone clamping apparatus is provided with a mobile phone clamping slot, and the lens connection arm is provided with a lens mounting portion. The lens connection arm is slidably provided at the mobile phone clamping apparatus and is rotatably connected to the mobile phone clamping apparatus, and one end of the lens connection arm provided with the lens mounting portion can rotate around the joint intersection between the lens connection arm and the mobile phone clamping apparatus. The adjustable mobile phone lens clamp can adapt to mobile phone cameras in different positions by changing the clamping position of the mobile phone clamping apparatus and rotating the lens connection arm. When the clamping position of the mobile phone clamping apparatus is restricted by a button on the mobile phone, the lens connection arm can be further slid to make the lens connection arm close to or away from the mobile phone camera. The spatial position of the expanded lens can be flexibly adjusted to adapt to the position of the mobile phone camera, thereby improving the flexibility of the mobile phone lens clamp when adjusting.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural diagram of an adjustable mobile phone lens clamp according to an embodiment of the present application.

FIG. 2 is an exploded structural schematic diagram of the adjustable mobile phone lens clamp in FIG. 1.

FIG. 3 is an exploded structural schematic diagram of the adjustable mobile phone lens clamp in FIG. 1.

FIG. 4 is a schematic structural diagram of a mobile phone clamping apparatus in FIG. 1.

FIG. 5 is a cross-sectional view along A-A′ line in FIG. 4.

FIG. 6 is a top view of the adjustable mobile phone lens clamp in FIG. 1.

FIG. 7 is a schematic structural diagram of the adjustable mobile phone lens clamp according to an embodiment of the present application.

FIG. 8 is a plane schematic structural diagram of the adjustable mobile phone lens clamp in FIG. 7.

FIG. 9 is a cross-sectional view at C in FIG. 8.

FIG. 10 is an exploded schematic structural diagram of the adjustable mobile phone lens clamp in FIG. 7.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” or “or/and” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or falls within the scope of protection claimed in the present application.

The present application provides an adjustable mobile phone lens clamp 1000.

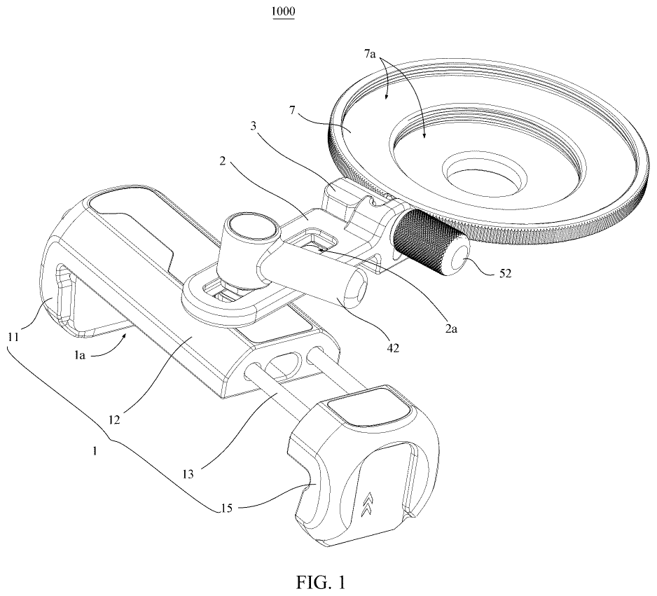

Referring to FIG. 1 to FIG. 3 and FIG. 7, in an embodiment, the adjustable mobile phone lens clamp 1000 includes a mobile phone clamping apparatus 1 and a lens connection arm. The mobile phone clamping apparatus 1 is provided with a mobile phone clamping slot 1a. The lens connection arm is provided with a lens mounting portion 3a. The lens connection arm is slidably provided at the mobile phone clamping apparatus 1 and is rotatably connected to the mobile phone clamping apparatus 1. One end of the lens connection arm provided with the lens mounting portion 3a can rotate around the joint intersection between the lens connection arm and the mobile phone clamping apparatus 1.

In this embodiment, the mobile phone clamping apparatus 1 is configured to connect to the mobile phone. The mobile phone can be clamped in the mobile phone clamping slot 1a. The mobile phone is abutted against or clamped with the inner wall of the clamping slot 1a, that is, the mobile phone clamping apparatus 1 can be clamped on the mobile phone, and the clamping position can be adjusted, for example, to avoid the position of the mobile phone button.

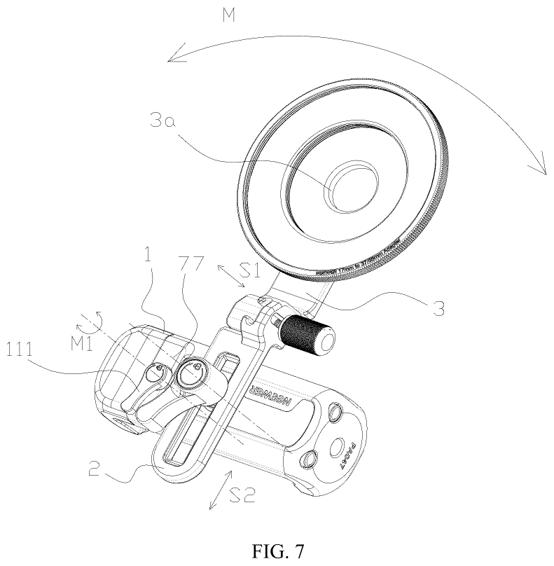

The lens connection arm can rotate relative to the mobile phone clamping apparatus 1, so that one end of the lens connection arm provided with the lens mounting portion 3a can rotate around the joint intersection between the lens connection arm and the mobile phone clamping apparatus 1. As shown in FIG. 7, the lens mounting portion 3a can swing around the axis 77 along the orientation M, so as to realize the alignment of the lens mounting portion 3a and the camera on the mobile phone. The lens mounting portion 3a is configured to realize the installation and fixation of the external expansion lens on the adjustable mobile phone lens clamp 1000. In addition, the lens connection arm can also slide relative to the mobile phone clamping apparatus 1 to further adjust the position of the lens mounting portion 3a relative to the camera on the mobile phone, so as to realize the alignment with the mobile phone camera. As shown in FIG. 7, the position of the lens mounting portion 3a can also be adjusted following the lens connection arm which can slide along the direction S2.

In order to realize that the lens connection arm can rotate relative to the mobile phone clamping apparatus 1 and can slide relative to the mobile phone clamping apparatus 1, a connection member can be provided to connect the lens connection arm and the mobile phone clamping apparatus, a rotating shaft can be provided on the connection member and a shaft hole can be provided on the mobile phone clamping apparatus 1, or the rotating shaft can be provided on the mobile phone clamping apparatus 1 and the shaft hole can be provided on the connection member to realize the rotation of the connection member and the mobile phone clamping apparatus. Furthermore, a sliding matching apparatus can be provided on the connection member and the lens connection arm, such as a sliding rail or a sliding groove, a convex and a sliding groove, and a sliding hole and a sliding shaft, etc.

The adjustable mobile phone lens clamp of this embodiment can adapt to mobile phone cameras in different positions by changing the clamping position of the mobile phone clamping apparatus and rotating the lens connection arm. When the clamping position of the mobile phone clamping apparatus is restricted by the button on the mobile phone, the lens connection arm can be further slid, so that the lens connection arm is moved closer to or away from the mobile phone camera. In this way, the spatial position of the expanded lens can be flexibly adjusted to adapt to the position of the mobile phone camera, which improves the flexibility of the mobile phone lens clamp when adjusting, and can adapt to the position of the camera of mobile phones in various models.

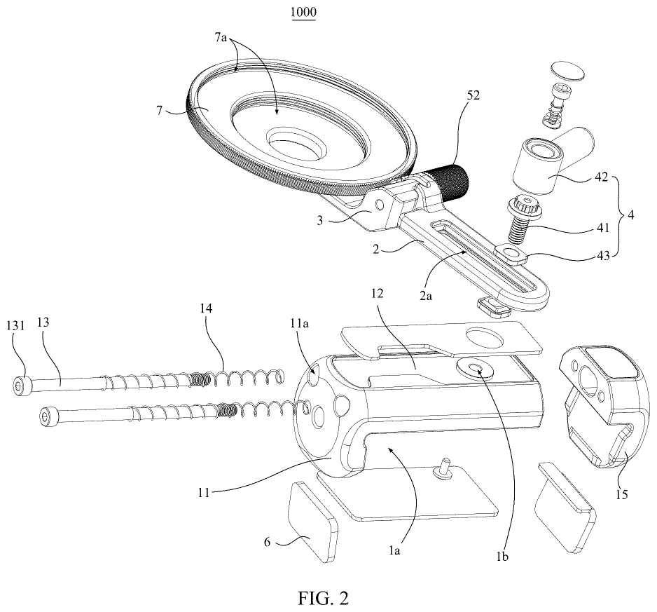

Further, referring to FIG. 2, in an embodiment, the adjustable mobile phone lens clamp 1000 further includes a first fastening apparatus 4, and the first fastening apparatus 4 includes a first fastener 41 and a first knob 42. The mobile phone clamping apparatus 1 is provided with a first mounting hole 1b, and the lens connection arm is provided with a first through hole 2a. The first fastener 41 is configured to pass through the first through hole 2a and extend into the first mounting hole 1b to be connected to the inner wall of the first mounting hole 1b, the first knob 42 is located on the side of the lens connection arm facing away from the mobile phone clamping apparatus 1 and is connected to the first fastener 41, and the first knob 42 is abutted against the periphery of the first through hole 2a.

In this embodiment, the first fastener 41 can be a screw rod, the inner wall of the first mounting hole 1b is provided with an internal thread, and the screw rod is screwed with the internal thread. A clamping slot matching the nut of the screw rod can be provided on the knob, and another screw rod can be provided to connect the knob and the first fastener 41, so as to prevent the first fastener 41 from being separated from the first knob 42. The first knob 42 can be integrated with or be fixed with the first fastener 41. The first fastener 41 can also be a rotating shaft, and the sidewall of the rotating shaft is provided with a clamping convex. The inner wall of the first mounting hole 1b is provided with a sliding groove 2b and a clamping slot communicated with the sliding groove 2b. The rotating shaft can be inserted into the first mounting hole 1b, and the clamping convex can slide along the sliding groove 2b into the first mounting hole 1b. The rotating shaft is driven to rotate by rotating the knob, and the clamping convex is rotated into the clamping slot and is clamped with the inner wall of the clamping slot. The above is only an example and should not be regarded as a limitation on the technical solution of the present application.

The first through hole 2a can be a circular hole or a strip-shaped slot, etc. The first fastener 41 is inserted into the first through hole 2a, and the first knob 42 is connected to the end of the first fastener 41 away from the first mounting hole 1b. The first knob 42 is to facilitate the manual operation of inserting the first fastener 41 into the first mounting hole 1b or rotating. Therefore, a convex can be provided on the outer wall of the first knob 42 to reduce the force required to rotate the first fastener 41 by lever principle, or a pattern can be provided on the outer wall of the first knob 42 to increase the friction when the hand contacts the knob. The end of the lens connection arm provided with the lens mounting portion 3a can rotate around the first fastener 41.

The first fastening apparatus 4 can realize the connection and fixation between the lens connection arm and the mobile phone clamping apparatus 1, that is, after the lens adapter hole is aligned with the mobile phone lens, the position of the first cantilever is fixed to prevent it from being moved again after alignment.

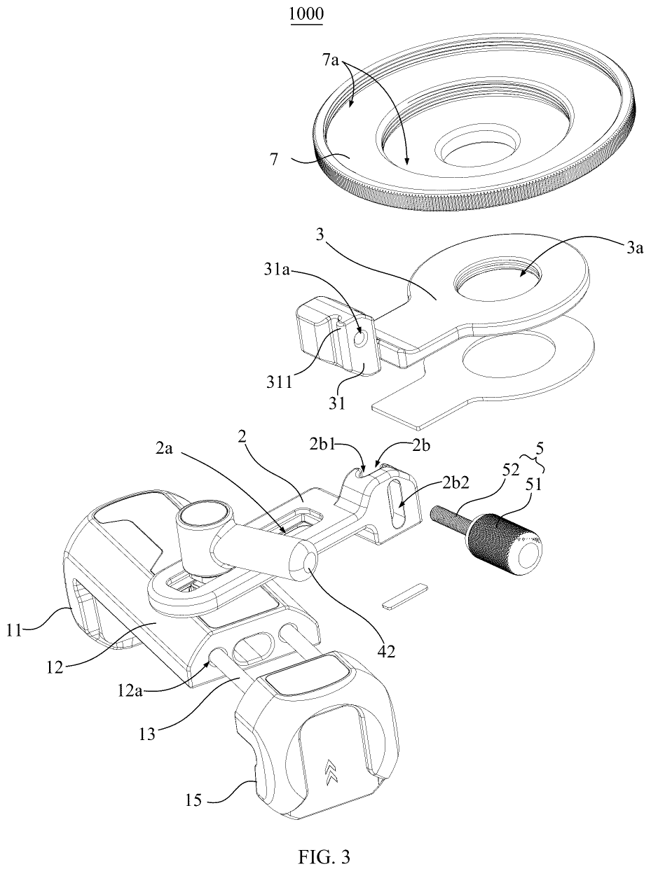

Further, referring to FIG. 2 to FIG. 3, in an embodiment of the present application, the first through hole 2a is a strip-shaped hole and/or a strip-shaped slot, and the first fastener 41 is inserted into the first through hole 2a and can move along the first through hole 2a; and/or, the first fastening apparatus 4 further includes a sliding block 43 sleeved on the first fastener 41 and slidably connected to the inner wall of the first through hole 2a.

In this embodiment, on the basis of the first connection arm 2 and the mobile phone clamping apparatus 1, the lens connection arm can slide relative to the mobile phone clamping apparatus, that is, the first fastener 41 can move along the first through hole 2a, and the relative position of the lens connection hole and the mobile phone clamping apparatus 1 can be further adjusted by sliding the lens connection arm, so as to adapt to the position of the mobile phone camera. This function significantly improves the adjustment flexibility of the mobile phone lens clamp when the side key of the mobile phone restricts the position of the mobile phone clamping apparatus 1.

The first through hole 2a is a strip-shaped hole, and the sliding block 43 can be square, rectangular or waist-shaped, etc. The sliding block 43 can be made of wear-resistant and relatively smooth metal or plastic material. The two parallel sidewalls of the sliding block 43 are slidably connected to the two opposite sidewalls of the first through hole 2a, so as to enhance the guiding property of the first through hole 2a and prevent the first fastener 41 from being worn.

Further, referring to FIG. 2 to FIG. 3, and FIG. 7, in an embodiment of the present application, the lens connection arm includes a first connection arm 2 and a second connection arm 3, the first connection arm 2 can be slidably provided on the mobile phone clamping apparatus 1 along the direction S2 and is rotatably connected to the mobile phone clamping apparatus 1, and the second connection arm 3 is provided with a lens mounting portion 3a. The second connection arm 3 is slidably connected to the first connection arm 2 along the direction S1 which is normal to the direction S2 and can be fixed when sliding to any position relative to the first connection arm 2, so as to adjust the distance between the lens mounting portion 3a and the mobile phone clamping apparatus 1.

In this embodiment, the end of the first connection arm 2 away from the second connection arm 3 is rotatably connected to the mobile phone clamping apparatus 1, and the end of the second connection arm 3 away from the first connection arm 2 is provided with a lens adapter hole. A thread or a clamped structure is provided in the lens adapter hole for connecting with the lens or the lens connection member. The first connection arm 2 can rotate relative to the mobile phone clamping apparatus 1 to adjust the position of the lens adapter hole and realize the alignment of the lens adapter hole and the mobile phone lens.

The sliding connection between the second connection arm 3 and the first connection arm 2 can be realized through the cooperation of the sliding rail 31 and the sliding groove 2b or the cooperation of the convex and the guide groove, etc. For example, the sliding rail 31 is provided on the first connection arm 2, and the sliding groove 2b matched with the sliding groove 2b is provided on the second connection arm 3. For another example, the convex is provided on the first connection arm 2, and the guide groove matched with the convex is provided on the second connection arm 3, etc. It should be noted that in the structure of the sliding rail 31 and the sliding groove 2b or the convex and the guide groove, the positions of the sliding rail 31 and the sliding groove 2b can be interchanged, and the positions of the convex and the guide groove can be interchanged without affecting the guiding function for sliding.

The adjustable mobile phone lens clamp 1000 of this embodiment can adapt to mobile phone cameras in different positions by changing the clamping position of mobile phone clamping apparatus 1 and rotating the first connection arm 2. By sliding the second connection arm, the second connection arm 3 is moved closer to or away from the mobile phone camera, so as to achieve the purpose of focusing, reduce the gap between the mobile phone camera and the expansion lens, and reduce the influence of light transmission through the gap on shooting. In addition, some mobile phone cameras on the market protrude from the back of the mobile phone, or some mobile phone protective cases have camera protection structures protruding from the back of the mobile phone protective cases. When the adjustable mobile phone lens clamp 1000 is applied to such mobile phones or mobile phones with mobile phone protective cases, the protruding structure may block the rotation of the lens connection arm, making it impossible for the extended lens to align with the mobile phone camera. The second connection arm 3 of this embodiment can slide relative to the first connection arm 2 to move away from or close to the back of the mobile phone. The second connection arm 3 can be adjusted to move the lens mounting portion 3a away from the back of the mobile phone, thereby avoiding the protruding structure for alignment. After the alignment is completed, the second connection arm 3 is adjusted to move the lens mounting portion 3a close to the back of the mobile phone. In this way, the spatial position of the extended lens can be flexibly adjusted to adapt to the position of the mobile phone camera, improving the flexibility of the mobile phone lens clamp when adjusting.

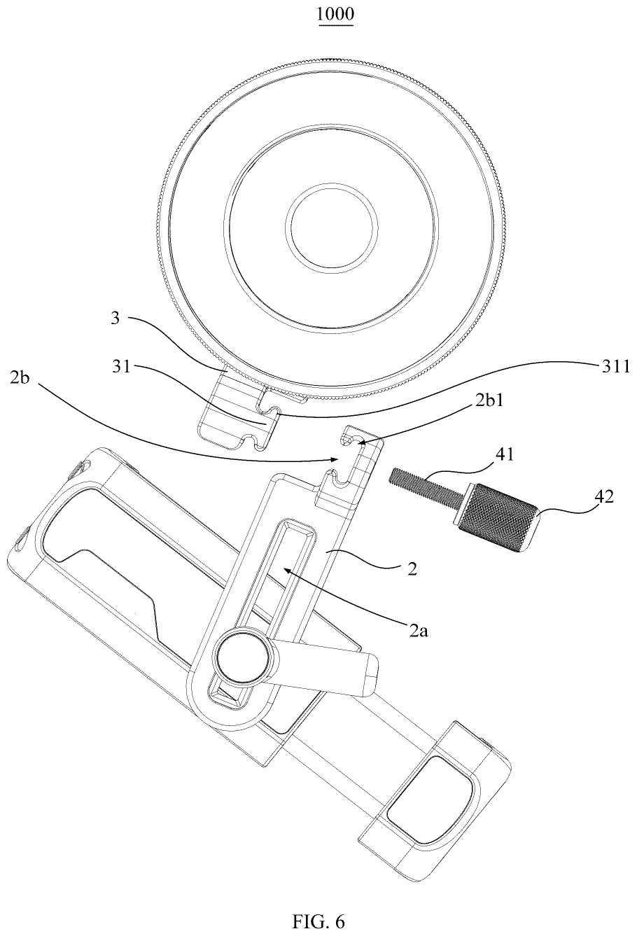

Further, referring to FIG. 3 and FIG. 6, in an embodiment of the present application, a sliding rail 31 extending in a direction from the first connection arm 2 to the mobile phone clamping apparatus 1 is provided on the second connection arm 3, a sliding groove 2b extending in a direction from the first connection arm 2 to the mobile phone clamping apparatus 1 is provided on the first connection arm 2, and the sliding rail 31 is slidably connected to the inner wall of the sliding groove 2b. In this embodiment, the sliding rail 31 can extend into the sliding groove 2b and can be slidably connected to the inner wall of the sliding groove 2b, and the sliding groove 2b and the sliding rail 31 can guide the sliding of the second cantilever and prevent the second connection arm 3 from rotating relative to the first connection arm 2, thereby reducing the movement complexity of the second connection arm 3 and facilitating the user's control. The sliding rail 31 can slide along the inner wall of the sliding groove 2b and approach or move away from the mobile phone camera to reduce the gap between the expansion lens and the mobile phone camera, and prevent excessive light from penetrating through the gap to affect shooting. Alternatively, some mobile phone cameras on the market protrude from the back of the mobile phone, the alignment of the extended lens and the mobile phone camera cannot be well achieved only by rotating the first connection arm 2, and the second connection arm 3 may be stuck by the protruding mobile phone camera. At this time, the sliding rail 31 can slide along the inner wall of the sliding groove 2b and drive the second connection arm 3 to approach or move away from the mobile phone camera to solve this problem.

Further, in order to prevent the sliding rail 31 from being separated from the notch of the sliding groove 2b, referring to FIG. 3 and FIG. 6, in an embodiment of the present application, the sidewall of the sliding rail 31 is provided with a convex rib 311 extending in the direction from the first connection arm 2 to the mobile phone clamping apparatus 1, the sidewall of the sliding groove 2b is provided with a limiting groove 2b1 extending in the direction from the first connection arm 2 to the mobile phone clamping apparatus 1, and the convex rib 311 is slidably connected to the inner wall of the limiting groove 2b1. In this embodiment, the extending direction of the limiting groove 2b1 and the extending direction of the convex rib 311 is the same as that of the sliding groove 2b, and the convex rib 311 is limited in the limiting groove 2b1 through the sidewall of the limiting groove 2b1, that is, the sliding rail 31 cannot leave the sliding groove 2b from the notch of the sliding groove 2b, thereby strengthening the connection between the first connection arm 2 and the second connection arm 3, preventing the second connection arm 3 from accidentally falling off, and further reducing the movement complexity of the second connection arm 3, so as to facilitate the user's control.

Further, referring to FIG. 3, in an embodiment, the adjustable mobile phone lens clamp 1000 further includes a second fastening apparatus 5, and the second fastening apparatus 5 includes a second fastener 51 and a second knob 52. The bottom wall of the sliding groove 2b is provided with a second through hole 2b2, and the second through hole 2b2 is a strip-shaped hole. The side of the sliding rail 31 facing the bottom wall of the sliding groove 2b is provided with a second mounting hole 31a. The second fastener 51 can pass through the second through hole 2b2 and can be connected to the inner wall of the second mounting hole 31a. The second knob 52 is located on the side of the second through hole 2b2 facing away from the sliding groove 2b and is connected to the second fastener 51.

In this embodiment, the second fastener 51 can be a screw rod, the inner wall of the second mounting hole 31a is provided with an internal thread, and the screw rod is screwed with the internal thread. A clamping slot matching the nut of the screw rod can be provided on the knob, and another screw rod can be provided to connect the knob and the second fastener 51 to prevent the second fastener 51 from being separated from the second knob 52. The second knob 52 can be integrated with or fixed with the second fastener 51. The second fastener 51 can also be a rotating shaft, and the sidewall of the rotating shaft is provided with a clamping convex. The inner wall of the second mounting hole 31a is provided with a sliding groove 2b and a clamping slot communicated with the sliding groove 2b, the rotating shaft can be inserted into the second mounting hole 31a, and the clamping convex can slide along the sliding groove 2b into the second mounting hole 31a. The rotating shaft is driven to rotate by rotating the knob, and the clamping convex is rotated into the clamping slot and is clamped with the inner wall of the clamping slot. The above is only an example and should not be regarded as a limitation on the technical solution of the present application.

The second through hole 2b2 is a strip-shaped hole. The second fastener 51 is inserted into the second through hole 2b2. The second knob 52 is connected to the end of the second fastener 51 away from the second mounting hole 31a. The second knob 52 is to facilitate the manual operation of inserting the second fastener 51 into the second mounting hole 31a or rotating. Therefore, a convex can be provided on the outer wall of the second knob 52 to reduce the force required to rotate the second fastener 51 by lever principle, or a pattern can be provided on the outer wall of the second knob 52 to increase the friction when the hand contacts the knob.

The second fastener 51 can move together with the second connection arm 3. By sliding the second knob 52, the second connection arm 3 can be driven to slide along the sliding groove 2b to adjust the distance between the expansion lens installed in the lens connection hole and the mobile phone camera. After the adjustment, the second knob 52 is rotated to lock the sliding rail 31 with the inner wall of the sliding groove 2b, that is, the first connection arm 2 is locked with the second connection arm 3.

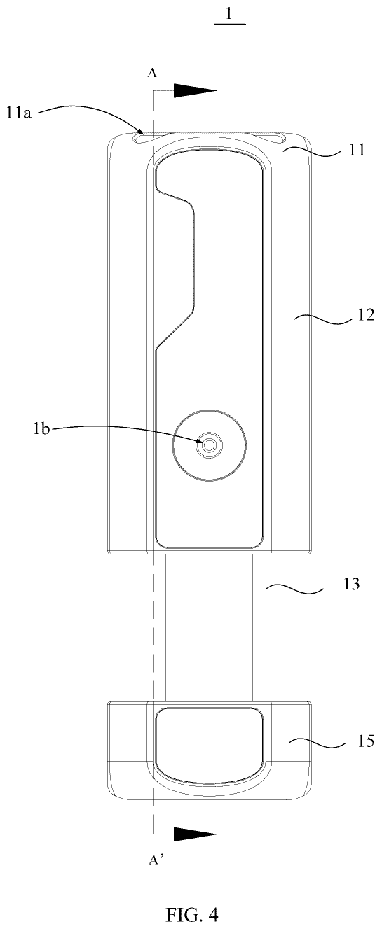

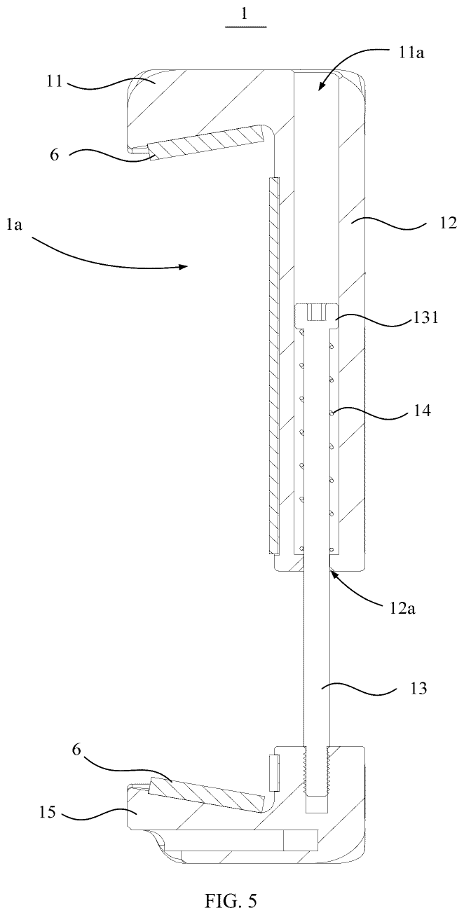

Further, referring to FIG. 4 and FIG. 5, in an embodiment of the present application, the mobile phone clamping apparatus 1 includes a first clamping claw 11, a connection block 12, a sliding rod 13, a spring 14 and a second clamping claw 15. The connection block 12 is rotatably connected to the first connection arm 2, and the first clamping claw 11 is fixedly connected to the connection block 12. A blind hole 11a is provided on a side of the first clamping claw 11 facing away from the connection block 12, and the blind hole 11a is configured to extend along the first clamping claw 11 towards the connection block 12 and extend into the connection block 12. A third through hole 12a is provided at the bottom wall of the blind hole 11a, and the sliding rod 13 is slidably penetrated through the third through hole 12a and can extend out of the connection block 12. A boss 131 is provided at the sidewall of the sliding rod 13, and the boss 131 is limited in the blind hole 11a. The second clamping claw 15 is located on the side of the connection block 12 facing away from the first clamping claw 11 is connected to the sliding rod 13, and a clamping slot is formed between the first clamping claw 11 and the second clamping claw 15. A spring 14 is sleeved on the sliding rod 13 and connected to the boss 131 and the bottom wall of the blind hole 11a, and the spring 14 is in a compressed state.

In this embodiment, the first clamping claw 11 and the second clamping claw 15 are provided relatively. When the first clamping claw 11 is relatively close to the second clamping claw 15, the mobile phone can be clamped between the first clamping claw 11 and the second clamping claw 15, a clamping slot is formed between the first clamping claw 11 and the second clamping claw 15, and the clamping slot can be a through slot. In order to improve the adaptability to various types of mobile phones and prevent the mobile phone from falling off easily, the clamping slot is gradually shrunk in the direction away from the bottom of the slot, that is, the sidewall of the clamping slot and the bottom wall are provided obliquely, and the angle between the sidewall of the clamping slot and the bottom wall is an acute angle.

The sliding rod 13 is slidably abutted against the inner wall of the third through hole 12a and can extend into the blind hole 11a. The other end of the sliding rod 13 away from the second clamping claw 15 is formed with a boss 131 limited in the blind hole 11a, and the boss 131 is larger than the third through hole 12a. The spring 14 is sleeved on the sliding rod 13 and the diameter of the spring 14 is smaller than the diameter of the boss 131 and larger than the diameter of the third through hole 12a. In this way, when the second clamping claw 15 is farthest from the first clamping claw 11, that is, when the mobile phone clamping apparatus 1 reaches the maximum clamping position, the spring 14 is completely compressed by the boss 131 and abutted against the bottom wall of the blind hole 11a. When the second clamping claw 15 is closest to the first clamping claw 11, that is, when the mobile phone clamping apparatus 1 reaches the minimum clamping position, the second clamping claw 15 is abutted against the connection plate.

In order to enhance the connection between the mobile phone clamping apparatus 1 and the mobile phone, an anti-slip pad 6 is provided on a side of the first clamping claw 11 facing the second clamping claw 15; and/or the anti-slip pad 6 is provided on a side of the second clamping claw 15 facing the first clamping claw 11. In this embodiment, the anti-slip pad 6 can enhance the friction between the anti-slip pad 6 and the mobile phone, and can also be deformed to a certain extent to fit the outer contour of the mobile phone, so that the mobile phone is embedded in the anti-slip pad 6, which further restricts the movement of the mobile phone in the clamping slot, and reduces the shaking of the adjustable mobile phone lens clamp 1000.

Further, referring to FIG. 3, in an embodiment, the lens mounting portion 3a is any one of a threaded mounting hole, a magnetic seat, a buckle, and a clip. In this embodiment, as shown in FIG. 3, a through hole is provided at one end of the lens connection arm away from the mobile phone clamping apparatus 1, so as to form a through-view condition when connected with the extended lens. Therefore, the shape of the through hole can be circular or square, etc. For the convenience of manufacturing and installation, the through hole is circular. A thread is provided on the inner wall of the through hole, i.e., a threaded mounting hole. The threaded mounting hole can be connected to a threaded lens. It can be understood that in order to form a through-view condition, the through hole is only one of the achievable methods, which can also be achieved through a notch provided on the connection arm or by directly connecting the extended lens to one side of the lens connection arm, etc., which will not be described in detail here. In this way, a magnetic seat, a buckle, a clip, etc. can also be provided on the lens connection arm to achieve the connection with a corresponding type of a magnetic lens or a buckle lens, etc.

Further, referring to FIG. 3, in an embodiment, the adjustable mobile phone lens clamp 1000 further includes a lens adapter ring 7 detachably connected to the inner wall of the lens adapter hole, and the lens adapter ring 7 is provided with at least two types of lens adapter grooves 7a.

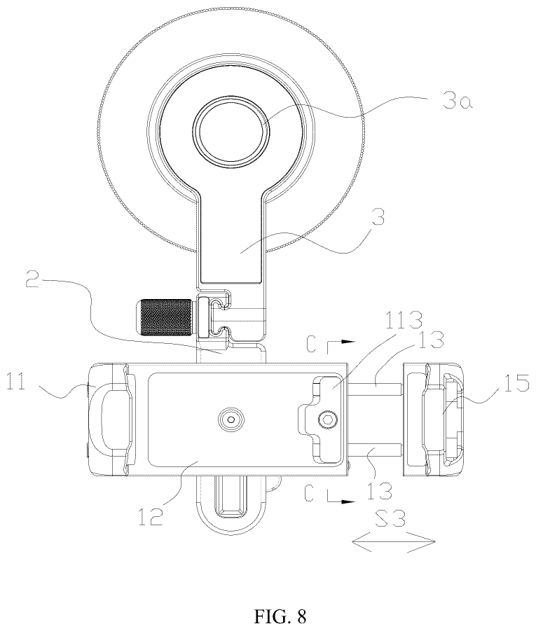

In an embodiment, referring to FIG. 7 to FIG. 10, the mobile phone clamping apparatus includes a first clamping claw 11, a connection block 12, a sliding rod 13 and a second clamping claw 15. The first clamping claw 11 is connected to the connection block 12, the second clamping claw 15 is connected to the sliding rod 13, the sliding rod 13 is slidably mounted at the connection block 12, and the space between the first clamping claw 11 and the second clamping claw 15 is formed with a mobile phone clamping slot 1a. The mobile phone clamping apparatus further includes a block assembly mounted at the connection block 12 and configured to clamp or loosen the sliding rod 13. The method of installing the sliding rod 13 on the connection block 12 can refer to FIG. 5, and the end boss 131 of the sliding rod 13 is restricted by the connection block 12 to prevent the sliding rod 13 from completely sliding out and disengaging from the connection block 12 when sliding to the limit position. When the block assembly releases the sliding rod 13, the sliding rod 13 is not subject to the pressure of the block assembly and can slide freely, and the second clamping claw 15 can be driven to slide to any position relative to the first clamping claw 11 to adjust the size of the mobile phone clamping slot 1a, so as to facilitate the installation of the mobile phone or to adapt to mobile phones of different sizes. When the second clamping claw 15 is adjusted to a suitable position, the block assembly clamps the sliding rod 13, and the sliding rod 13 can not slide relative to the connection block 12, so that the mobile phone clamping slot 1a between the first clamping claw 11 and the second clamping claw 15 is fixed. In an embodiment, a second block assembly can also be provided. The first clamping claw 11 can also be connected to another sliding rod, and the other sliding rod can also slide relative to the connection block 12. The second block assembly is installed on the connection block 12 and is configured to clamp or release the other sliding rod, that is, in this embodiment, the first clamping claw 11 and the second clamping claw 15 both slide relative to the connection block 12.

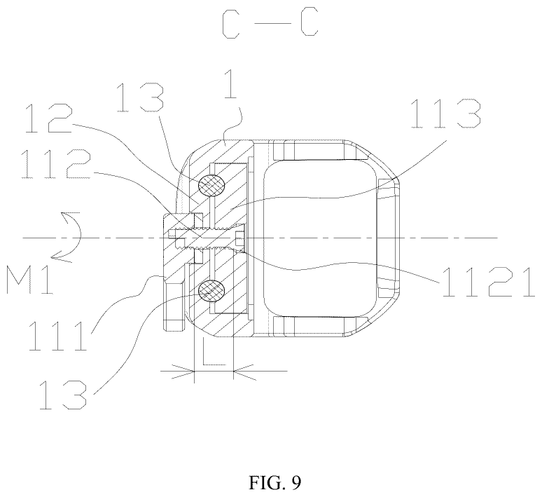

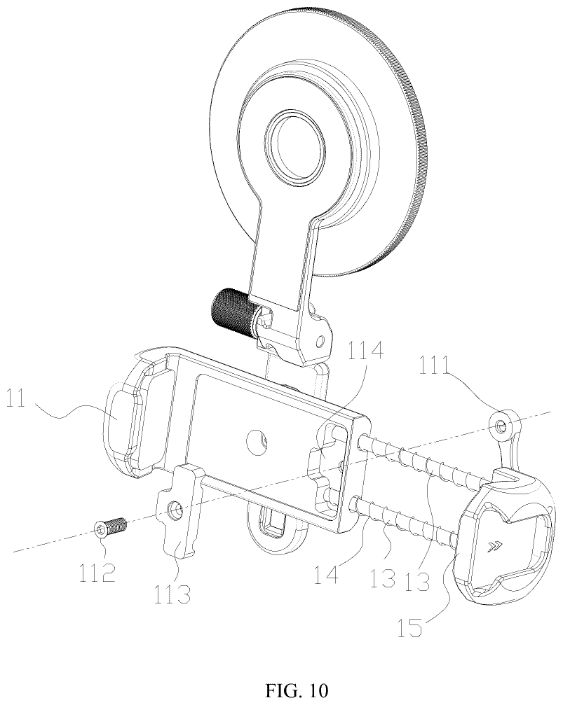

In an embodiment, referring to FIG. 9, the block assembly includes a bolt 112, a rotary knob 111, and a block 113. One end of the bolt 112 passes through the block 113 and the connection block 12 in sequence and is threadedly connected to the rotary knob 111, and the other end of the bolt 112 is restricted to the block 113. Referring to FIG. 9 and FIG. 10, the connection block 12 is provided with an accommodation port 114, the sliding rod 13 passes through the accommodation port 114, and the block 113 is installed at the accommodation port 114, so that the block 113 can tighten or release the sliding rod 13. The head 1121 of the bolt 112 is stuck on one end of the block 113 to restrict the bolt 112 to the block 113, and the threaded section of the bolt 112 passes through the block 113, the connection block 12, and the block 113 located at the accommodation port 114 and is threadedly connected to the rotary knob 111.

Referring to FIG. 7 and FIG. 9, when the rotary knob 111 is rotated around the direction M1, the edge of the rotary knob 111 presses against the connection block 12 and is screwed deeper into the bolt 112, that is, the distance L between the head 1121 of the bolt 112 and the rotary knob 111 becomes shorter, thereby driving the bolt 112 to tighten the block 113 to approach and press against the sliding rod 13, so that the friction between the sliding rod 13 and the block 113 limits the sliding of the sliding rod 13 relative to the connection block. When the rotary knob 111 is rotated reversely, the rotary knob 111 is gradually screwed out of the bolt 112 to an extent, that is, the distance L between the head 1121 and the rotary knob 111 becomes longer, thereby driving the bolt 112 to push the block 113 in a direction away from the sliding rod 13, and releasing the sliding rod 13, so that the sliding rod 13 can slide relative to the connection block 12.

Further, referring to FIG. 5, in an embodiment, the adjustable mobile phone lens clamp also includes a spring 14 configured to drive the second clamping claw 15 to move toward the first clamping claw 11 after the block 113 releases the sliding rod 13.

In this embodiment, the back of the lens adapter ring 7 is configured to extend into the lens adapter hole and is connected to the inner wall of the lens adapter hole, and the front of the lens adapter ring 7 is provided with multiple layers of lens adapter grooves 7a. Each layer of the lens adapter grooves 7a corresponds to a diameter of the extended lens, and a threaded structure or a clamped structure is provided in the lens adapter groove 7a for connecting to the extended lens.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. An adjustable mobile phone lens clamp, comprising:
a mobile phone clamping apparatus provided with a mobile phone clamping slot; and
a lens connection arm provided with a lens mounting portion,
wherein the lens connection arm is slidably provided at the mobile phone clamping apparatus and is rotatably connected to the mobile phone clamping apparatus, and one end of the lens connection arm provided with the lens mounting portion is configured to rotate around a joint intersection between the lens connection arm and the mobile phone clamping apparatus.

2. The adjustable mobile phone lens clamp according to claim 1, further comprising a first fastening apparatus, wherein:
the first fastening apparatus comprises a first fastener and a first knob, and the mobile phone clamping apparatus is provided with a first mounting hole;
the lens connection arm is provided with a first through hole, and the first fastener is configured to pass through the first through hole and extend into the first mounting hole to be connected to an inner wall of the first mounting hole; and
the first knob is provided at one side of the lens connection arm facing away from the mobile phone clamping apparatus and is connected to the first fastener, and the first knob is abutted against a periphery of the first through hole.

3. The adjustable mobile phone lens clamp according to claim 2, wherein the first through hole is a strip-shaped slot, and the first fastener is configured to pass through the first through hole and is configured to slide along the strip-shaped slot.

4. The adjustable mobile phone lens clamp according to claim 2, wherein the first through hole is a strip-shaped slot, the first fastening apparatus further comprises a sliding block sleeved at the first fastener and slidably connected to an inner wall of the strip-shaped slot.

5. The adjustable mobile phone lens clamp according to claim 1, wherein the lens connection arm comprises a first connection arm and a second connection arm, the first connection arm is slidably provided at the mobile phone clamping apparatus and is rotatably connected to the mobile phone clamping apparatus, and the second connection arm is provided with the lens mounting portion; and
the second connection arm is slidably connected to the first connection arm and is fixed in response to sliding to any position relative to the first connection arm, so as to adjust a distance between the lens mounting portion and the mobile phone clamping apparatus.

6. The adjustable mobile phone lens clamp according to claim 5, wherein the second connection arm is provided with a sliding rail extending in a direction from the first connection arm to the mobile phone clamping apparatus, the first connection arm is provided with a sliding groove extending in the direction from the first connection arm to the mobile phone clamping apparatus, and the sliding rail is slidably connected to an inner wall of the sliding groove.

7. The adjustable mobile phone lens clamp according to claim 6, wherein a sidewall of the sliding rail is provided with a convex rib extending in the direction from the first connection arm to the mobile phone clamping apparatus, a sidewall of the sliding groove is provided with a limiting groove extending in the direction from the first connection arm to the mobile phone clamping apparatus, and the convex rib is slidably connected to an inner wall of the limiting groove.

8. The adjustable mobile phone lens clamp according to claim 6, further comprising a second fastening apparatus, wherein:
the second fastening apparatus comprises a second fastener and a second knob;
a bottom wall of the sliding groove is provided with a second through hole, the second through hole is a strip-shaped hole, and a second mounting hole is provided on one side of the sliding rail towards the bottom wall of the sliding groove; and
the second fastener is configured to pass through the second through hole and is connected to an inner wall of the second mounting hole, and the second knob is provided on one side of the second through hole facing away from the sliding groove and is connected to the second fastener.

9. The adjustable mobile phone lens clamp according to claim 1, wherein the mobile phone clamping apparatus comprises a first clamping claw, a connection block rotatably connected to the lens connection arm, a sliding rod, a spring and a second clamping claw;
the first clamping claw is fixedly connected to the connection block, a blind hole is provided on one side of the first clamping claw facing away from the connection block, the blind hole is configured to extend along a direction from the first clamping claw to the connection block and extend into the connection block, and a third through hole is provided on a bottom wall of the blind hole;
the sliding rod is slidably through the third through hole and is configured to extend outside the connection block, a boss is provided on a sidewall of the sliding rod, and the boss is limited in the blind hole;
the second clamping claw is provided on one side of the connection block facing away from the first clamping claw and connected to the sliding rod, and the clamping slot is formed between the first clamping claw and the second clamping claw; and
the spring is sleeved at the sliding rod and is connected to the boss and the bottom wall of the blind hole, and the spring is in a compressed state.

10. The adjustable mobile phone lens clamp according to claim 1, wherein the lens mounting portion is any one of a threaded mounting hole, a magnetic seat, a buckle and a clip.

11. The adjustable mobile phone lens clamp according to claim 1, further comprising a lens adapter ring detachably connected to an inner wall of the lens mounting portion, wherein the lens adapter ring is provided with at least two lens adapter grooves.

12. The adjustable mobile phone lens clamp according to claim 1, wherein the mobile phone clamping apparatus comprises a first clamping claw, a connection block, a sliding rod and a second clamping claw;
the first clamping claw is connected to the connection block, the second clamping claw is connected to the sliding rod, the sliding rod is slidably mounted at the connection block, and the mobile phone clamping slot is formed between the first clamping claw and the second clamping claw; and
the adjustable mobile phone lens clamp further comprises a block assembly mounted at the connection block and configured to clamp or release the sliding rod.

13. The adjustable mobile phone lens clamp according to claim 12, wherein the block assembly comprises a bolt, a rotary knob and a block;
one end of the bolt is configured to pass through the block and the connection block in sequence and is threadedly connected to the rotary knob, and another end of the bolt is limited by the block;
in response to that the rotary knob is rotated forwardly, the rotary knob is abutted against the connection block, and the bolt is driven to tighten the block to approach and press against the sliding rod, so as to limit a sliding of the sliding rod relative to the connection block; and
in response to that the rotary knob is rotated reversely, the bolt is driven to push the block in a direction away from the sliding rod, so as to release the sliding rod to facilitate sliding of the sliding rod relative to the connection block.

14. The adjustable mobile phone lens clamp according to claim 12, further comprising a spring configured to drive the second clamp claw to move close to the first clamp claw in response to that the sliding rod is released by the block.
